(19) United States
(12) Patent Application Publication
(10) Pub. No.: US 2008/0278007 A1
(43) Pub. Date: Nov. 13, 2008

(54) EMERGENCY SHUTDOWN METHODS AND ARRANGEMENTS

(76) Inventor: Steven Clay Moore, Austin, TX (US)

Correspondence Address: SCHUBERT OSTERRIEDER & NICKELSON PLLC, 6013 CANNON MTN DR, S14, AUSTIN, TX, 78749, US

(21) Appl. No.: 11/744,928

(22) Filed: May 7, 2007

(51) Int. Cl. H01H 35/00

(52) U.S. Cl. 307/116

(57) ABSTRACT

Methods and arrangements to shut down equipment in response to voice command(s) are disclosed. More specifically, embodiments interpret voice command(s) from a person in the vicinity of equipment and respond by deactivating equipment. In some embodiments, a voice interpreter couples with a receiver located at the equipment to determine whether a person has voiced a command to shut down the equipment. In further embodiments, persons in the vicinity of equipment have transmitters to re-transmit the command to the equipment. In other embodiments, a voice interpreter is provided to those persons. In several embodiments, voice command(s) may shut down more than one piece of equipment and, in some embodiments, logic identifies pieces of equipment to shut down based upon, e.g., the location of the person, other equipment that may be affected, or the like. Some embodiments are preprogrammed to recognize “STOP” or a panicked scream in the voice of equipment operators.

### FIELD OF INVENTION

The present invention is in the field of emergency shutdown systems. More particularly, the present invention relates to methods and arrangements to shut off or shut down equipment in response to recognition of a voice or voice command. Embodiments may significantly improve safety of potentially dangerous equipment in, e.g., emergency situations in which deactivation via a manual switch or button may afford additional danger, damage, and/or is impractical or impossible.

### BACKGROUND

Most equipment such as industrial machines and even some household tools come with emergency cut-off or shutdown switches, which are also commonly referred to as kill switches. The switches are simple mechanical switches that typically connect to a control circuit for the equipment. Upon activation of the switch, power to the equipment is removed to shutdown the equipment. The emergency shutdown switches are designed to improve safety while operating the equipment by providing the operator with an easy and obvious way shut off the machine instantly. The switches are often required by a health and safety code such as the National Electric Code because they can save the operator's life and/or stop a minor problem from spiraling into a disaster. For example, work sites such as construction sites, industrial plants, and manufacturing facilities typically have large, potentially dangerous machinery or equipment. Workers that work in the vicinity of such large equipment often go through safety training for working with the equipment, working in the vicinity of the equipment, and handling emergency situations related to or within the vicinity of the equipment. With regards to handling emergency situations, the workers are trained on procedures for shutting down equipment at the site and the location of the emergency shutdown switches for the equipment.

Though there are many different versions of emergency shutdown switches, many are still simple buttons, usually big, red and positioned close to the machine operator. The emergency shutdown switches at work sites may also be connected in parallel with a contact of an emergency shutdown system. Emergency shutdown systems typically include a controller such as a programmable logic controller (PLC) that monitors processes throughout the work site for pre-defined conditions that warrant the shutdown of one or more pieces of equipment. These emergency shutdown systems do not replace but compliment the emergency shutdown switches. More specifically, emergency shutdown switches allow workers in the vicinity of the equipment to respond immediately to an emergency situation that may not be recognized immediately by the emergency shutdown system. For example, an accident involving a worker or a failure of a subsystem of the equipment may not be immediately detectable by the emergency shutdown system but may be recognized by a worker in the vicinity of the equipment. The worker or a co-worker can then hit the big red button typically located on the control panel for the equipment to reduce or end danger related to the operation of that equipment.

The problem with these emergency shutdown switch arrangements is that the emergency shutdown switches are typically located on or very near the equipment. Consistently positioning the emergency shutdown switch on the control panel for each piece of equipment allows the emergency shutdown switch for any particular piece of equipment to be quickly recognized even given the stress associated with emergency situations. Positioning the emergency shutdown switch on the control panel also allows an operator at the control panel or next to the equipment to quickly reach the emergency shutdown switch. However, placing the emergency shutdown switches on the equipment, forces the worker who is some distance away from the equipment to approach the equipment to press the emergency shutdown switch.

In some situations, approaching the equipment may be dangerous and the danger may or may not be obvious to the worker. When the danger is obvious, the worker may call in the problem to the control room and request that the equipment be shutdown, possibly losing precious seconds. When the danger is not obvious such as situations in which an invisible gas has been released or portions of the equipment are reaching dangerous stress limits, the worker may be seriously injured or killed while attempting to reach the emergency shutdown switch. Further, if the worker nearest to the equipment is injured, pinned down, pulled, or otherwise movement restricted, the worker may be unable to reach the emergency shutdown switch and, in some situations, unable to report the problem.

Some current emergency shutdown switch arrangements address the problem of having to approach the equipment to depress the button. Such solutions add remote emergency shutdown switches some distance from the equipment. The remote switches must be clearly marked as the emergency shutdown switch for a particular piece equipment to avoid confusion. However, adding remote emergency shutdown switches may, nonetheless, lead to confusion because equipment at work sites are often located in close proximity to one another. The location of remote emergency shutdown switches are also typically restricted by the availability of space on structures near the equipment. Thus, the locations of remote emergency shutdown switches are not consistent throughout the work site and workers must remember or search for uniquely positioned remote switches in emergency situations. Further, an injured worker may be unable to find or go to the local or remote emergency shutdown switch quickly.

Emergency shutdown switch arrangements for vehicles are also inadequate. Such arrangements often severely limit the operator's mobility and, for that reason, many operators bypass the switches. For example, boating is a popular but potentially dangerous, sport. Boating is particularly dangerous when the boat operator loses control of the boat, allowing the boat to leave the operator in choppy water or to hit an object, the operator, or another person, particularly when the boat is propeller driven.

Existing safety measures for boats and other watercraft include a tethered, engine, emergency shutdown switch. The operator manually attaches a tether to, e.g., the operator's wrist and, when the operator moves farther away from the controls than the tether allows, the tether is designed to pull, e.g., a key or lever, which stops the engine. The idea is that if the operator leaves the area of the control panel involuntarily, the engine stops, eventually causing the boat to stop. For situations in which the operator is thrown overboard, the emergency shutdown switch may also minimize the chance that operator is hit by the boat. However, the tethered, emergency shutdown switch does not offer a direct safety measure for passengers. Further, the tethered, emergency shutdown switch severely limits the mobility of the operator and, as a result, many operators do not attach the tether to themselves, defeating the measure of safety offered by the tethered switch.

Therefore, there is a need for methods and arrangements to shut down equipment in response to a voice command. Many such embodiments may advantageously improve safety of potentially dangerous equipment by providing a quick, remote, emergency shutdown switch arrangement for workers or operators in the vicinity of the equipment.

### SUMMARY OF THE INVENTION

The problems identified above are in large part addressed by methods and arrangements to shut down equipment in response to recognition of a voice or voice command. One embodiment provides a system to shut down equipment via a voice command. The system may comprise a voice receiver to receive the voice command. A voice command interpreter may identify features of the voice command, compare the features against one or more patterns of features stored in memory to associate the voice command with an instruction to shut down the equipment, and output a command signal in response to associating the voice command with the instruction. Then, a shutdown module may be coupled with the voice command interpreter to shut down the equipment in response to receipt of the command signal.

One embodiment provides a method methods and arrangements to shut down equipment via a voice command. The method generally involves receiving the voice command; identifying features of the voice command and comparing the features against one or more patterns of features stored in memory to associate the voice command with an instruction to shut down the equipment. In response to associating the voice command with the instruction, the method may generate a command signal. Then, the method may shut down the equipment in response to the command signal.

A further embodiment provides a machine-accessible medium containing instructions to shut down equipment via a voice command, which when the instructions are executed by a machine, cause said machine to perform operations. The operations may comprise receiving the voice command; identifying features of the voice command and comparing the features against one or more patterns of features stored in memory to associate the voice command with an instruction to shut down the equipment. The operations may further generate a command signal in response to associating the voice command with the instruction and shut down the equipment in response to the command signal.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of work site with equipment having a voice-activated shutdown switch in addition to local and remote emergency shutdown switches;

FIG. 2 depicts an embodiment of a system to shut down equipment in response to recognition of a voice command such as the system described for FIG. 1;

FIG. 3 depicts an embodiment of a control circuit for the equipment in FIG. 1;

FIG. 4 depicts an embodiment of wearable system to shut down equipment in response to recognition of a voice command;

FIG. 5 illustrates an embodiment of the wearable system such as the wearable system in FIG. 4;

FIG. 6 depicts an embodiment of a hard hat having an integrated voice-activation device to shut down equipment;

FIG. 7 depicts a flow chart of an embodiment to shut down equipment in response to recognition of a voice command; and

FIG. 8 depicts a flow chart of an embodiment to capture a voice command from a person.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

### INTRODUCTION

Generally speaking, methods and arrangements to cut-off or shut down equipment in response to a voice or voice command are disclosed. More specifically, embodiments interpret a voice command from a person in the vicinity of the equipment and respond by deactivating equipment. In some embodiments, a voice command interpreter at the equipment couples with a receiver to determine whether a person has voiced a command to shut down the equipment. In further embodiments, persons in the vicinity of the equipment wear a transmitter to transmit the voice command to the equipment and, then, the voice command interpreter determines whether the person commanded the shut down of the equipment. In other embodiments, voice command interpreters are worn by workers in the vicinity of the equipment. The voice command may then be interpreted before transmitting a command to shut down the equipment. In several of these embodiments, the voice command may shut down more than one piece of equipment in the vicinity and, in some of these embodiments, a logic module identifies a pattern of equipment shut downs in the vicinity of the worker and proceeds to shut down further equipment based upon, e.g., the perceived location of the worker, other equipment that is likely to be affected, or the like. The logic module may also interface with other systems to instruct the other systems to perform actions in response to the voice command such as initiating announcements, triggering alarms, or the like.

Embodiments may interpret a scream of terror or other excited utterance as a voice command or interpret one or more words as voice commands. In many embodiments, each worker may provide one or more voice patterns, words, excited utterances, or the like to the voice command interpreter to allow the voice command interpreter to more accurately interpret sounds it receives from each of these workers. In some embodiments, the voice command interpreter couples closely with the neck, cheek, skull, or other surface of a worker to pickup vibrations from the worker in place of or in addition to sound waves transmitted through the air surrounding the worker.

In several embodiments, placement of the voice command interpreter may be based upon a signal-to-noise ratio (SNR) associated with the location, a convenience of the location for the workers, an ease of verification for health and safety reasons, a preferred location for a transmission capability of the voice interpreter, protection of the voice command interpreter, or a balance or combination of one or more of these or other factors. For instance, one embodiment integrates the voice command interpreter or sound re-transmitter with a hard hat, capturing the voice or signal through a head band or a separate connection with the worker. Such embodiments can locate at least environmentally sensitive components inside the shell of the hard hat without inconveniencing the worker.

Optionally, the components of the voice command interpreter or sound re-transmitter may reside in a sealed module that meets one or more NEMA (National Electrical Manufacturer Association) standards for hazardous environments and may attach to, e.g., a hard hat. The sealed module may comprise interconnects to receive vibrations from the operator and possibly from a receiver for ambient noise from the exterior of the hard hat. Such embodiments can also include an indication such as a sticker, part of the voice interpreter or sound re-transmitter, or other marker on the outside of the hard hat to visually indicate the presence of the voice interpreter or sound re-transmitter. Further embodiments include a visual indicator that the voice interpreter have sufficient power to operate and some of these embodiments include an integrated system to recharge a battery via an integrated solar panel while in use or via a separate power supply while not in use.

While portions of the following detailed discussion describe embodiments of the invention in specific types of voice or speech recognition analyses, embodiments implementing other forms of voice or speech recognition analyses are also contemplated.

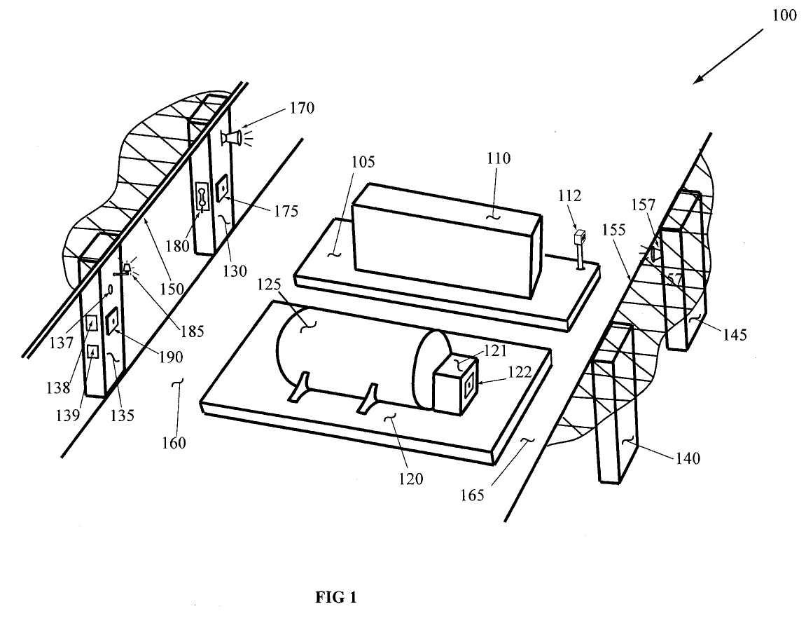

Turning now to the drawings, FIG. 1 depicts an embodiment of a voice command, emergency shut down system implemented in, e.g., a small area 100 of a processing plant. The small area 106 includes two equipment packages 105 and 120 and columns 130, 135, 140, and 145 to support upper-level areas 150 and 155. For clarity, FIG. 1 does not show the piping and cabling to and from packages 105 and 120.

Packages such as package 105 and package 120 are typically purchased from a vendor that specializes in building the type of equipment included in the package. The packages 105 and 120 may include motors, pumps, tanks, agitators, instrumentation, solenoid controls, valves, and/or the like. Electrical instrumentation and control may be gathered into one or more enclosures on the package to allow easy access for wiring, fiber optics, instrument air, etc. to facilitate remote monitoring and control over the process performed by the package. For instance, package 120 includes a control panel 121 that provides access to motor controls. A large, red, emergency stop button 122 is located on the outside of the panel so the button is easily identifiable and accessible in case of an emergency. By pressing the large, red button, a worker in walkway 165 can shut down the equipment on package 120.

Package 105 may also include one or more control panels. However, the control panels are either not easily accessible or do not offer a convenient, easily identifiable and accessible location for a large, red emergency stop button 112. As a result, the vendor for package 105 built a mount specifically to position emergency stop button 112 in an easily identifiable and accessible location. Thus, if a worker in the vicinity of package 105 notices by sight, sound, or smell that some failure is occurring with equipment 110 on package 105, the worker may hit emergency stop button 112 to shut down the equipment.

An emergency shutdown system (not shown), which is located in a central control room for area 100 of the processing plant, includes computers, programmable logic controllers (PLCs), and other equipment to monitor the status of processes performed by packages 105 and 120 as well as parameters of the processes and other factors such as the temperature of motor windings. If any parameter and/or other factor alone, or in combination, are indicative of an equipment failure, the emergency shutdown system may activate a relay that deactivates the corresponding equipment and, in some embodiments, other equipment.

In the present embodiment, additional safety equipment is mounted on the columns 130, 135, and 145. In particular, the safety equipment mounted on column 130 includes a loud speaker 170, a remote shut down switch 175, and a public announcement (PA) telephone 180. Loud speaker 170 may provide a means to speak to workers in area 100. In some situations, the announcements may be made from a central control room and, in other embodiments, the announcements may be made from PA telephone 180 or similar phone connected to the PA system.

Remote shutdown switch 175 may provide a remote means for shutting down equipment 110. For example, if a worker in walkway 160 recognizes a problem with the operation of equipment 110, the worker may hit the large, red button of emergency shutdown switch 175 to shut down equipment 110. In many such embodiments, emergency shutdown switch 175 is identified as the shutdown switch for equipment 110 via, e.g., a nameplate.

PA telephone 180 may be part of a PA system and may allow a person to make public announcements in one or more areas of the work site and/or provide a private line to another location in the work site such as the central control room or an adjacent office location. For example, PA telephone 180 may be a GAI-Tronics® phone and may include switches to select between available lines for PA telephone 180.

In some embodiments, workers may use the PA system to annunciate voice commands in various locations that can be selected via the PA system. In further embodiments, the PA system may interconnect with a voice command interpreter 138 wirelessly or via an optic, copper, or other hardwired communications medium to transmit a voice command from one or more PA telephones such as PA telephone 180 to voice command interpreter 138.

The safety equipment mounted on column 135 includes a remote voice command receiver 137, voice command interpreter 138, a shutdown module 139, a strobe light 185, and a remote shut down switch 190. Remote voice command receiver 137 may be a microphone adapted to receive sounds, voices, or voice commands in area 100. In some embodiments, a filter included with receiver 100 is adapted to reduce noise captured by receiver 137. For instance, the filter may comprise a bandpass filter to eliminate noise having frequencies outside frequencies of typical voices. In many embodiments, the filter may also filter out repetitive or ambient noise received by receiver 137.

Upon capturing sounds, receiver 137 forwards the sounds to voice command interpreter 138. In many embodiments, the sounds are then digitally sampled by voice command interpreter 138 via an analog to digital (A/D) converter to facilitate speech recognition. Similarly, receiver 157 on column 145 captures, and possibly filters sounds received. Then receiver 157 transmits the sounds via an electrical conductor, optical fiber, or other communications medium.

Voice command interpreter 138 determines whether a voice command is included within the sounds received from receivers 137 and 157. In several embodiments, a voice command may be a scream from a worker. In further embodiments, the voice command may be a spoken or yelled word or phrase. In one embodiment, more than one voice command may be recognized, each capable of being associated with a unique instruction. For instance, a voice command “shut down area” may be associated with an instructions to shut down all equipment in the area of the person that uttered the command such as area 100. A voice command “shut down all” may be associated with an instruction to shut down equipment in area 100 as well as all adjacent areas. And, a voice command “evacuate area” may be associated with an instruction to initiate a preprogrammed announcement to evacuate area 100, or whichever area the person is in that uttered the command. Many other potential commands are also contemplated.

Voice command interpreter 138 may search sounds received for one or more key features that are indicative of the voice command. For instance, voice command interpreter 138 may analyze sounds in time frames adapted to display a phoneme or a combination of phonemes. A phoneme is the smallest phonetic unit of a voiced sound that distinguishes one word from another, such as “c” and “r” in the pronunciations of “cat” and “rat”.

As the phonemes are identified in time frames of speech, probabilities are calculated to determine the likelihood of error in identification of the phonemes as well as a probability that the word or phrase represented by the phonemes is a voice command. If the probability that the combination of phonemes is a voice command is higher than a preset threshold, voice command interpreter 138 may conclude that a voice command has been voiced by a worker and output a signal to shutdown module 139.

Embodiments may also provide a means for adjusting the ranges of frequencies and/or amplitudes to search for to identify phonemes so that the sensitivity of the voice command interpreter 138 can be adjusted. For instance, voice command interpreter 138 may estimate and remove a fundamental frequency of sounds to remove the fundamental frequency of a voice command. Voices of different people vary, at least in part based upon a fundamental frequency generated via each person's vocal cords. Thus, removing the fundamental frequency of the voice command reduces variations between voice commands uttered by different people and, thus, pronunciations of the phonemes of a word or phrase. Then, comparisons with phonemes stored in a library may be simpler and result in a higher probability of accuracy.

In several embodiments, the voice command interpreter 138 comprises data storage or other memory to maintain a library of phonemes and/or combinations of phonemes that make up a voice command. In some embodiments, workers at the work site may record the voice command(s) before entering the work site and the phonemes associated with each workers' voice command(s) may be available to each voice command interpreter at the work site or at least for the voice command interpreters in the areas of the work site that the workers have authorization to enter.

In other embodiments, voice command interpreter 138 may be located in a central control room and one voice command interpreter may handle the interpretation of sounds from one or more areas like area 100. In such embodiments, voice command interpreter 138 may couple with a central data storage device that includes key features for voice commands received in each area of the work site.

Another embodiment is adapted to be worn by each worker at the work site. In some of these embodiments, the workers wear a receiver. In other embodiments, the workers wear the receiver and a voice command interpreter, which may advantageously be programmed to interpret commands from that particular worker. In further embodiments, the worker may also wear the shutdown module such as shutdown module 139 and the shutdown module may wirelessly transmit commands to equipment within reception area of the worker. A corresponding receiver in the area of the worker or, in one embodiment, on each piece of equipment, may respond by shutting down equipment in the vicinity of the worker.

Once voice command interpreter 138 determines that a voice command has been received, voice command interpreter 138 transmits an indication of the voice command to shutdown module 139. In many embodiments, shutdown module 139 simply shuts down equipment packages in the area such as equipment packages 105 and 120. For instance, shutdown module 139 may open a contact in control circuits for each piece of equipment in area 100 and thereby disconnect power from the equipment.

In other embodiments, shutdown module 139 may have more than one programmed responses depending upon the voice command received and/or the area from which the voice command is received. For example, shutdown module 139 may be programmed to not only shut down the equipment in area 100 but also to initiate a preprogrammed, area-wide, multi-area, or work site wide announcement regarding the shut down of the equipment in area 100. In particular, shutdown module 139 may couple with the PA telephone system and may be adapted to select one or more announcements depending upon the voice command received.

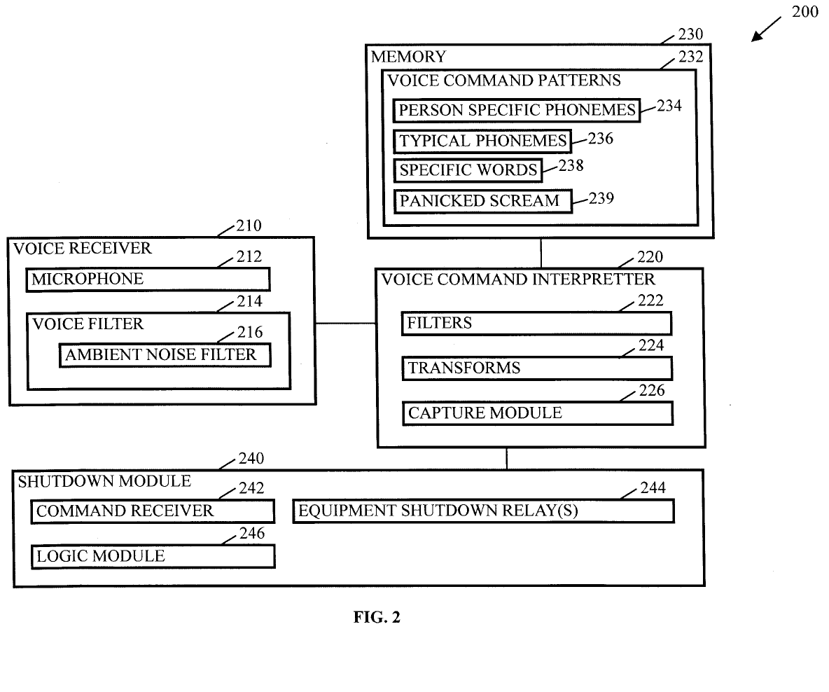

FIG. 2 depicts a system 200 for shutting down equipment in response to a voice command. In particular, system 200 offers improved safety for situations in which use of a physical switch may be infeasible or otherwise ineffective. System 200 comprises a voice receiver 210, a voice command interpreter 220, a memory 230, and a shut down module 240. Voice receiver 210 may comprise a microphone 212 to receive sounds that may be a voice command and a voice filter 214 to filter out sounds that are not within frequencies typically uttered by people when speaking, yelling, and/or screaming. For instance, voice filter 214 may filter out frequencies above 20 kilohertz (KHz) and below 2 KHz. Voice filter 214 may also include an ambient noise filter 216. Ambient noise filter 216 may capture patterns of repetitive sounds and filter those sounds out of the sounds received prior to transmitting the sounds to voice command interpreter 220.

Voice command interpreter 220 may analyze sounds received from voice receiver 210 to determine whether the sounds comprise a voice command. More specifically, voice command interpreter 220 couples with memory 230 to compare phonemes of sounds received against voice command patterns 232. The voice command patterns 232 may include typical patterns of phonemes 236 for persons voicing the voice command and/or patterns of specific persons 234 that may utter or have authorization to utter the voice command. In the present embodiment, voice command patterns 232 also comprises specific words 238 and panicked scream 239. Specific words 238 may comprise features of recordings for specific words or recordings of specific words from specific persons, or typical voice patterns or features thereof for specific words. For example, workers may record one or more specific words to be stored in specific words 238. In some embodiments, the specific words stored in memory 230 are raw or substantially raw recordings. In further embodiments, the specific words 238 are processed recordings or portions thereof. In one embodiment, workers are recorded uttering words at specific locations within a work location to capture background noise and/or the effect of background noise on the words.

Panicked scream 239 may comprise recordings, features of recordings, or typical voice patterns associated with panicked screams. In some embodiments, the panicked screams may be generic. In further embodiments, the panicked screams include data related to panicked screams performed by specific workers. For instance, one embodiment includes both panicked screams of specific workers and a generic panicked scream for comparison against voice commands captured within a work location for interpretation by voice command interpreter 220.

Voice command interpreter 220 may include filters 222, transforms 224, and a capture module 226. Filters 222 may include frequency and/or relative amplitude filters to remove noise and also sounds that probabilities suggest are unlikely to be phonemes, or portions thereof, included in voice command patterns 232 of memory 230. Transforms 224 may include mathematical manipulations such as Fourier transforms, inverse Fourier transforms, or other mathematical transforms that help identify or accentuate phonemes within the received sounds, which may be indicative of a voice command.

Capture module 226 is adapted to capture voice commands from persons for storage in person specific 234 voice command patterns 232 of memory 230. When voice command interpreter 220 is switched into a command recording mode, voice capture module 226 captures phonemes of the voice after the command is transformed via transforms 224. Then, capture module 226 stores the key features of the voice command in person specific 234 voice command patterns 232 of memory 230. In other embodiments, capture module 226 may store the voice command rather than or in addition to key features of the voice command. In such embodiments, voice command interpreter 220 may utilize the recording of the voice command and/or the phonemes to identify voice commands. For example, phonemes may help to quickly identify a possible voice command from all the sound received and then a comparison of the identified voice command against the recorded voice command may confirm that the sounds comprise the voice command if the identified voice command is similar to the recorded voice command.

Shutdown module 240 may be responsive to voice command interpreter 220 to shut down equipment, initiate announcements on a PA telephone system, trigger an alarm, or the like. Shutdown module 240 comprises a command receiver 242, an equipment shutdown relay(s) 244, and a logic module 246. Command receiver 242 may receive a signal from voice interpreter 220 and respond with a pre-determined response. For instance, when voice command interpreter 220 is designed to recognize a single voice command and provide an indication to shutdown module 240 upon receipt of the command, command receiver 242 may identify receipt of the signal and signal equipment shutdown relay(s) 244 to shut down equipment. On the other hand, when voice command interpreter 220 is designed to distinguish between more than one voice commands, voice command interpreter 220 may output a signal indicative of the voice command received. In response, command receiver 242 may interpret the signal and respond accordingly by signaling equipment shutdown relay(s) 244 and/or logic module 246.

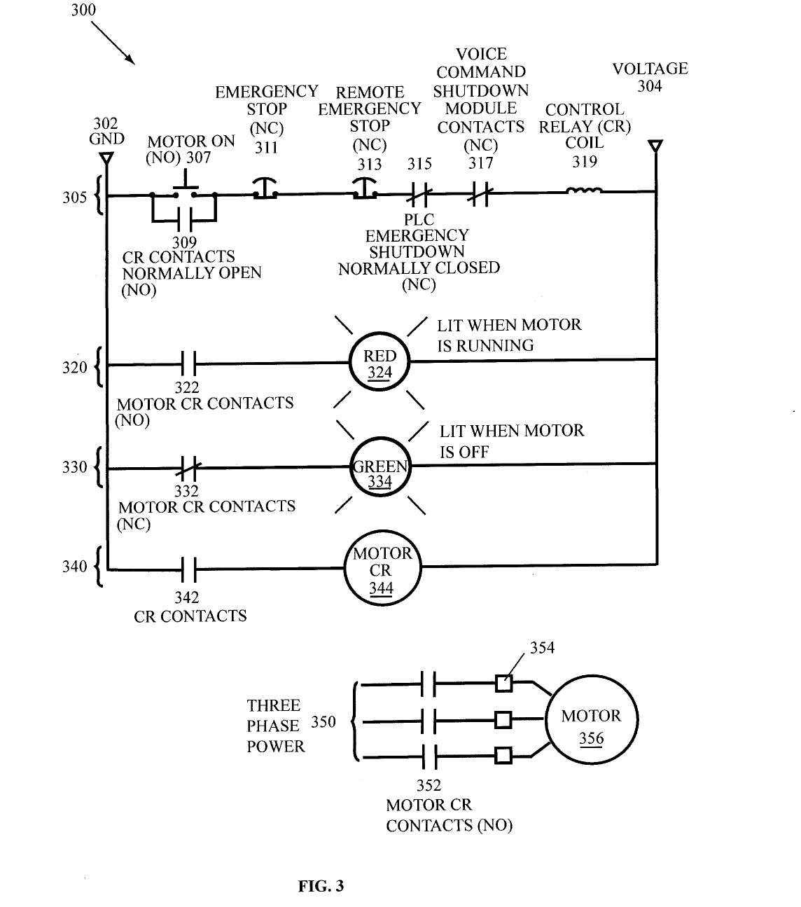

Equipment shutdown relay(s) 244 may include one or more relays having contacts in control circuits for equipment. Upon receiving a signal from command receiver 242, a coil of the relay(s) may be activated or deactivated, causing the contacts within the control circuits to change states to deactivate the corresponding equipment. In further embodiments, deactivation may include activation of brakes. Activation of the brakes can be triggered whenever the moving portion of the equipment is off by, e.g., including, in parallel a motor control circuit such as the motor control circuit shown in FIG. 3, a coil to activate the brakes in series with a normally-closed (NC) motor control relay (CR) contacts. In other embodiments, activation of the brakes may be triggered by, e.g., normally-open (NO) contacts of a voice command shutdown module and/or contacts associated with other emergency stop relays or switches such that the brakes are activated when the motor is stopped via an emergency shutdown system.

In some embodiments, shutdown module 240 is included within the control circuit for a single piece of equipment. In other embodiments, shutdown module 240 may comprise logic for shutting down more than one piece of equipment.

Logic module 246 may signal other systems and/or shutdown modules in response to a voice command to instruct the other systems to perform actions in response to the voice command. For instance, logic module 246, upon receipt of an indication that a voice command has been received by command receiver 242, may communicate with a PA telephone system to initiate an announcement, trigger an alarm in a control room, trigger strobe lights in the area from which the voice command was received, and/or signal shutdown modules for other equipment to shut down. When command receiver 242 is capable of distinguishing between more than one voice command, logic module 246 may respond differently to each of the commands.

FIG. 3 depicts a control circuit 300 for a motor 356 having shutdown contacts 317 for shutting down motor 356 in response to a voice command. Control circuit 300 represents one possible control arrangement for a small motor 356 at a work site such as work site 100 of FIG. 1. In some embodiments, different arrangements may be necessary due to the lengths of cable involved in bringing contacts from various switches together to form control circuit 300.

Control circuit 300 comprises two rails, ground (GND) 302 and voltage 304, to supply power to components coupled between the rails. Components are coupled between rails 302 and 304 in four parallel paths 305, 320, 330, and 340. Path 305 provide a control interface to a user and for various automated switches. In particular, path 305 includes a normally-open, motor-on switch 307 for turning on motor 356. Normally-open switch or contacts leave the circuit between the rails 320 and 304 open when the switch or contacts are not activated. For example, motor-on switch 307 is normally-open because a spring prevents the switch from closing the path 305 unless a force is applied to the switch 307. Similarly, contacts that are normally-open, maintain an open circuit between the rails unless a voltage is applied across the coil that controls the contacts. On the other hand, normally-closed switches and contacts maintain a path between the rails 302 and 304 unless the switch is activated or a voltage is applied across the relay coil, respectively.

In path 305, if motor-on switch 307 is pressed, control relay (CR) coil 319 is energized because the switches and contacts in series with motor-on switch 307 are all normally closed. Energizing coil 319 closes the normally-open, CR contacts 309, which is connected in parallel with motor-on switch 307, to maintain a closed path between rails 302 and 304 when motor-on switch 307 is released. Path 305 then remains closed until one of the normally-closed switches or contacts coupled in series with coil 319 is activated to open the circuit.

The normally-closed switches and contacts include an emergency stop button 311, a remote emergency stop button 313, programmable logic controller (PLC) emergency shutdown contacts 315, and voice command, shutdown module contacts 317. Emergency stop button 311 may be a large, red button located on a control panel for equipment such as emergency shutdown switch 122 in FIG. 1. Remote emergency shutdown button 313 is a large, red button located some distance from motor 356 to allow a person in the vicinity of remote emergency shutdown button 313 to shut down motor 356 without approaching motor 356, such as emergency shutdown switch 190 of FIG. 1. PLC emergency shutdown contacts 315 comprise contacts wired into control circuit 300 from a PLC. The PLC may, for instance, shut down motor 356 in case of a catastrophic problem with a process, the stability of the electrical system, or other. And, voice command shutdown module contacts 317 may comprise contacts wired into control circuit 300 from a shutdown module that is adapted to shut down motor 356 in response to receipt of a voice command.

Path 320 turns on a red indication light 324 when motor CR coil 344 is energized. In particular, energizing coil 319 closes CR contacts 342, which closes the circuit path between rails 302 and 304 in path 340, energizing motor CR coil 344. Energizing motor CR coil 344 closes motor CR contacts 322, energizing red indication light 324.

Path 330 turns on a green indication light 334 when motor CR coil 344 is not energized and turns off green indication light 334 when motor CR coil 344 is energized. More specifically, energizing coil 319 opens CR contacts 342, which opens the circuit path between rails 302 and 304 in path 340, de-energizing motor CR coil 344. De-energizing motor CR coil 344 opens motor CR contacts 332, de-energizing green indication light 334.

Motor 356 is part of an equipment package such as package 105 or 120 of FIG. 1. Motor 356 couples with a three-phase power supply 350 via motor terminals 354 and motor CR contacts 352. When motor-on switch 307 is pressed, CR coil 319 is energized, closing CR contacts 342. Closing CR contacts 342 energizes motor CR coil 344, closing motor CR contacts 352 and closing motor CR contacts 352 applies the three-phase power supply to coils of motor 356. In other embodiments, motor 356 may be a larger motor and alternate methods of starting motor 356 may be implemented such as a soft start to reduce the stress and strain placed on the coils and/or on the three-phase power supply 350.

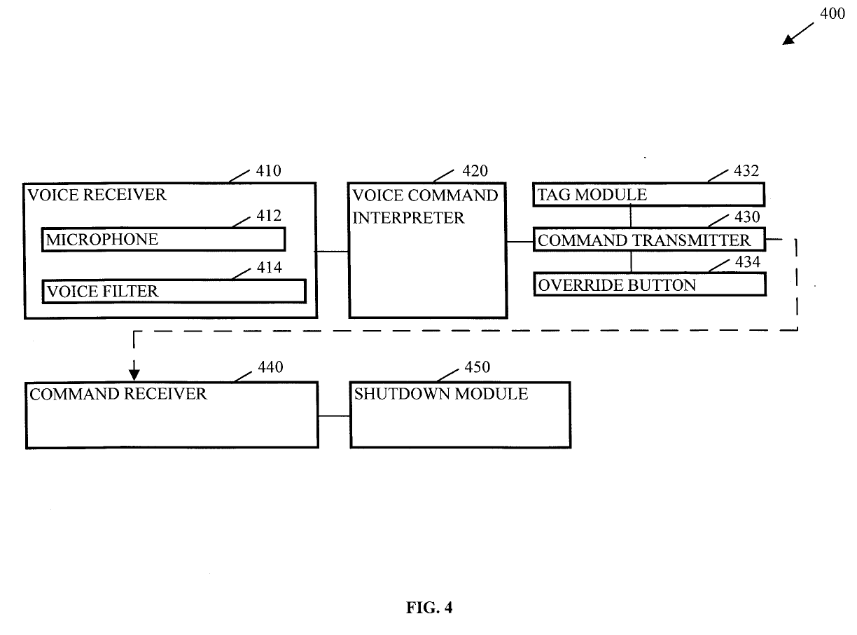

FIG. 4 depicts a system 400 for shutting down equipment in response to a voice command. System 400 is designed to be worn by persons in the vicinity of the equipment although system 400 may be well-suited for other uses as well. System 400 offers improved safety for situations in which use of a physical switch may be infeasible or otherwise ineffective. System 400 comprises a voice receiver 410, a voice command interpreter 420, a command transmitter 430, a tag module 432, an override button 434, a command receiver 440, and a shutdown module 450. Voice receiver 410 may comprise a microphone 412 and a vibration sensor 414. Microphone 412 picks up sounds, which are filtered based upon the vibrations sensed by vibration sensor 414 to isolate the voice command uttered by the person wearing system 400. In other embodiments, voice receiver 410 may not include a microphone 412 and may sense voice commands based upon a pattern of vibrations sensed by vibration sensor 414.

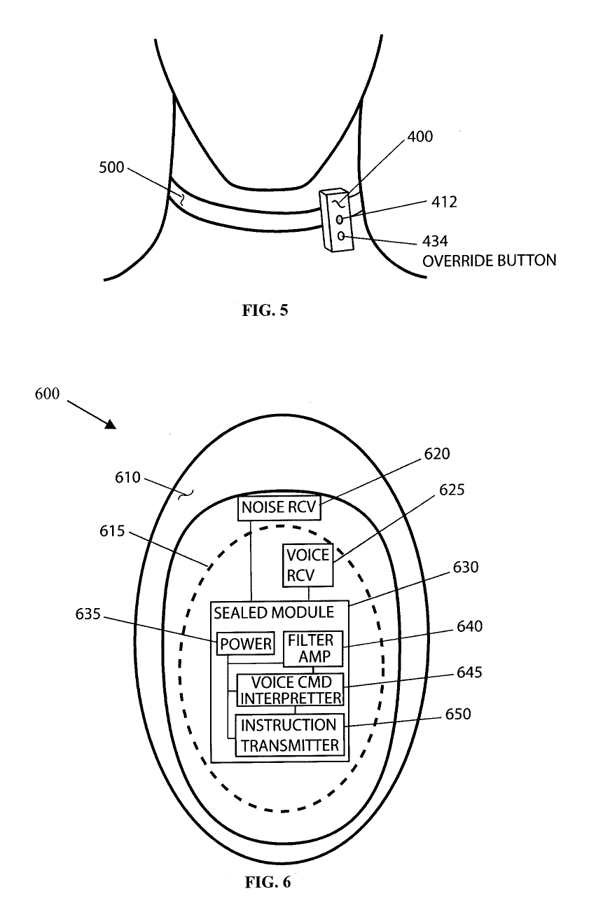

FIG. 5 illustrates an embodiment of system 400 being worn by a person. System 400 is held against the skin over the neck, cheek, or skull bone of the person via a band 500 to allow vibration sensor 414 to pick up vibrations resulting from speech by the person. Microphone 414 picks up the sound waves produced by the vibrations of the persons vocal cords.

Referring again to FIG. 4, voice command interpreter 420 interprets the sounds filtered by the vibrations to determine whether the person uttered a voice command. In other embodiments, voice command interpreter 420 may receive both the sounds picked up by the microphone 412 and the vibrations picked up by the vibration sensor 414. Then, voice command interpreter 420 may filter the background noise from the sounds based upon the vibrations to improve the signal-to-noise ratio (SNR).

After filtering background noise with the input from the vibration sensor and possibly additional mathematical processes such as convolution, deconvolution, correlation, transformation, masking, frequency filtering, amplitude filtering, amplitude correction, and the like, voice command interpreter 420 may compare the resulting signal(s) against a number of voice commands stored in memory of the voice command interpreter 420. For example, voice command interpreter 420 may comprise one or more state machines, processors and code, and/or other logic to process raw analog, sound data from the microphone 412 and the vibration sensor 414. The processed sound data may comprise a representation of aspects or characteristics of the sound for comparison against representations of voice commands in the memory. In some embodiments, each person whom is authorized to announce a voice command may be recorded and the recorded voice commands or representations thereof may be stored in the memory for later comparison. In several embodiments, ambient noise at various locations may be stored upon initialization of system 400 and/or periodically throughout the life of system 400 to capture additional data for processing and identifying voice commands.

In many embodiments, each potential operator of system 400 may yell “STOP” and/or one or more other predetermined exclamations for storage in the memory of voice command interpreter 420. In such embodiments, voice command interpreter 420 may comprise logic to compare the recorded voice commands against a received voice command and may optionally associate voice commands with an operator based upon the initial recordings of the predetermined exclamations by each potential operator. In one embodiment, a representation of a scream of terror by a human voice may be stored in the memory to facilitate recognition of such by logic of voice command interpreter 420 as an instruction to shut down associated equipment.

When voice command interpreter 420 identifies a voice command in the sounds and/or vibrations, voice command transmitter 420 indicates the reception of the voice command to command transmitter 430. Command transmitter 430 is adapted to transmit wirelessly, an indication of the reception of the voice command to command receiver 440. In many embodiments, the transmission is a code sequence and, in further embodiments, the code sequence is encrypted to prevent the code from being captured by unauthorized persons. For example, the person may be at a work site, see a problem with equipment such as equipment 110 in FIG. 1, and annunciate a voice command to shut down equipment 110. Voice receiver 410 may pick up the vibrations from the voiced command, the sound waves produced when voicing the command, and background noise emanating from equipment packages such as packages 105 and 120. Filtration of the sounds received by voice receiver 410 via the vibrations may substantially distinguish the voice command from the background noise. Then, voice command interpreter 420 may identify the voice command and, in response, output a signal to command transmitter 430.

In the present embodiment, command transmitter 430 couples with tag module 432 and override button 434. Tag module 432 is adapted to add an identification to the signal transmitted to command receiver 440 to uniquely identify command transmitter 430. In many embodiments, the identification of command transmitter 430 may also, advantageously, identify the person that uttered the voice command.

Override button 434 is a switch that allows the person wearing command transmitter 430 to transmit the emergency shutdown command to command receiver 440 without voicing the command. Thus, if the person is unable to speak for some reason, the person can effect shut down of the equipment by pressing the button. For example, a pipe containing a dangerous gas may rupture and a worker in the vicinity may notice the rupture. The worker knows that approaching the rupture to hit the emergency shutdown button would be dangerous and knows that breathing the gas could be deadly, so the worker holds his breath while leaving the area and presses the override button 434. In response, the equipment near the ruptured pipe is shut down and an announcement over the PA system instructs all workers in the vicinity of the rupture to leave the area.

Command receiver 440 may be located on an equipment package in the vicinity of the person or may be mounted on a structure in the vicinity of the worker. Upon receipt of the wireless transmission from the person, command receiver 440 instructs shutdown module 450 to shut down the corresponding equipment.

FIG. 6 depicts an embodiment of a hard hat 600 having a voice-activated device to shutdown equipment in the vicinity of the operator wearing the hard hat 600 in response to a voice command. More specifically, hard hat 600 comprises a shell 610, a head band 615, a noise receiver 620, a voice receiver 625, and a sealed module 630. Shell 610 may be a hard plastic, metal, or other hard material designed to protect the head from impact from an object such as a falling object at a job site. Head band 615 connects the head of an operator with shell 610 and away from shell 610 to distribute the force substantially evenly about the head of the operator to reduce the chance of serious injury to the operator.

Noise receiver 620 and voice receiver 625 may comprise devices to propagate vibrations to sealed module 630. In particular, noise receiver 620 may couple with shell 610 to receive vibrations from sound received at the exterior of hard hat 600. Noise receiver 620 may also couple with sealed module 620 to transmit the vibrations associated with the exterior sounds to sealed module 630. On the other hand, voice receiver 625 may couple with head band 615 and/or otherwise couple with the head of the operator such as via a separate band to capture vibrations propagated via the skull bone of the operator. Voice receiver 625 transmits the vibrations to sealed module 630.

Sealed module 630 may be a module sealed in a manner to meet health and safety codes in hazardous environments such as environments in which one or more gases may accidentally be released into the atmosphere. In the present embodiment, sealed module 630 has a NEMA type 4X rating. Sealed module 630 comprises a power source 635, a filter and amplifier 640, a voice command interpreter 645, and an instruction transmitter 650. Power source 635 may be a rechargeable battery and can be recharged while hard hat 600 is not being used. In some embodiments, a solar panel can charge power source 635 during use. In many embodiments, the solar panel may be attached to shell 610 or be attached to the clothing of the operator.

Filter and amplifier 640 may process vibrations received from noise receiver 620 and voice receiver 625 to attenuate noise and/or improve the SNR. In the present embodiment, filter and amplifier 640 removes background noise represented by the vibrations received from noise receiver 620 from the voice represented by vibrations from voice receiver 625. The voice may then be amplified and transmitted to voice command interpreter 645.

Voice command interpreter 645 compares the voice with voice commands stored in memory of voice command interpreter 645 to determine whether a voice command has been uttered by the operator. If a voice command is recognized, the corresponding instruction is indicated to instruction transmitter 650 for transmission to an instruction receiver (not shown) within the vicinity of the operator. The instruction receiver may then transmit the instruction to a shutdown module (not shown) to shut down equipment in the vicinity of the operator.

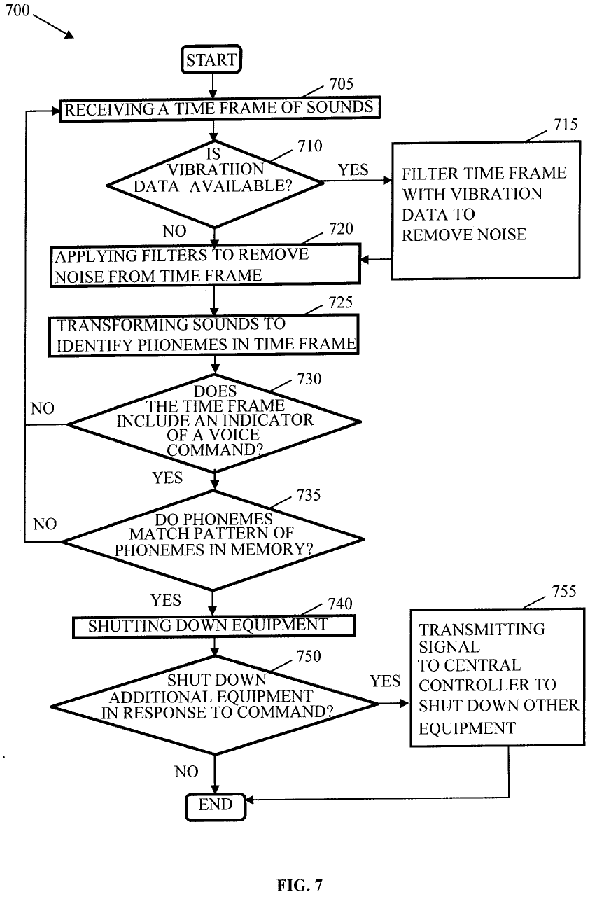

Referring now to FIG. 7, there is shown a flow chart 700 of an embodiment to shut down equipment in response to recognition of a voice command. Flow chart 700 begins with receiving a time frame of sounds (element 705). For example, a voice command interpreter may receive a twenty second window of sounds from a receiver or may receive updates every second but may maintain the last 19 seconds in a queue.

If vibration data is available to filter noise from the time frame (element 710) then the time frame is filtered with the vibration data (element 715) and then additional filters may be applied to remove noise (element 720). Otherwise, the additional filters may be applied to the remove the noise (element 720). For example, a bandpass filter may remove frequencies below 5 KHz and above 15 KHz. In further embodiments, filters may be applied to remove, e.g., frequencies that are not included in stored phonemes for voice command patterns.

Once noise has been filtered out of the time frame, a transform such as a Fourier transform may be applied to the time frame to accentuate phonemes or combinations of phonemes of the time frame (element 725). The voice command interpreter may then search the twenty-second time frame, or at least the most recently received portion of the time frame for a phonemes or other indicator that the time frame may comprise a voice command. If no indicator is found within the time frame, the voice interpreter may advantageously save time by skipping comparisons against voice command patterns stored in the memory and waiting to receive and search additional time frames at element 705. On the other hand, if the time frame includes an indicator of a voice command such as one or more phonemes in an order that is likely associated with a voice command (element 730), the time frame may be time-aligned with voice command patterns stored in memory via the phonemes and compared against one or more patterns of phonemes stored in the memory that represent a voice command (element 735).

Upon comparing the phonemes of the time frame against a voice command pattern, voice command interpreter may determine whether the time frame includes a voice command. If the time frame does not include a voice command, the voice interpreter may wait for the next time frame of sound at element 705. On the other hand, if the time frame includes a voice command, the voice interpreter may instruct a shutdown module to shut down equipment (element 740).

In some embodiments, the shutdown module may include logic to shut down other pieces of equipment in response to the voice command (element 745). If the voice command is associated with the shut down of additional equipment, the logic module may transmit a signal to a central controller to shut down the additional equipment (element 750).

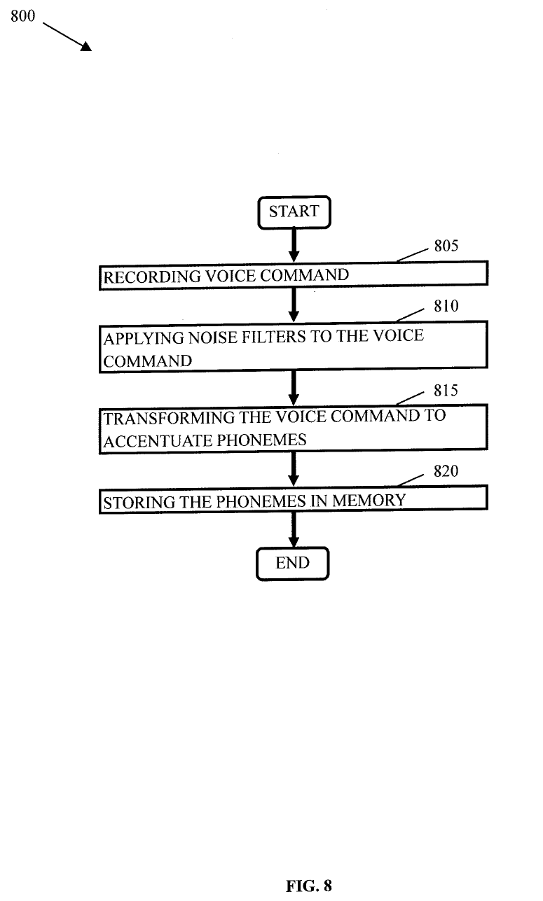

FIG. 8 depicts a flow chart 800 of an embodiment to capture a voice command from a person. Flow chart 800 begins with recording a voice command (element 805). For example, holding a record or program button down on a voice interpreter may implement a voice command capture module that records a voice command (element 805). The voice interpreter may apply filters to remove noise from the voice command (element 810), apply one or more transforms to the voice command to accentuate key features like phonemes (element 815), and stores a pattern of the key features that represent the voice command in memory (element 820).

One embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., hard-disk drive or floppy disks within a diskette drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It will be apparent to those skilled in the art having the benefit of this disclosure that the present invention contemplates methods and arrangements to shut off or shut down equipment in response to recognition of a voice command. It is understood that the form of the invention shown and described in the detailed description and the drawings are to be taken merely as examples. It is intended that the following claims be interpreted broadly to embrace all the variations of the example embodiments disclosed.

What is claimed is:

1. An emergency shutdown system to shut down equipment via a voice command, the system comprising:
a voice receiver to receive the voice command;
a voice command interpreter to identify features of the voice command, compare the features against one or more patterns of features stored in memory to associate the voice command with an instruction to shut down the equipment, and output a command signal in response to associating the voice command with the instruction; and
a shutdown module coupled with the voice command interpreter to shut down the equipment in response to the command signal.

2. The system of claim 1, further comprising a command transmitter coupled with the voice command interpreter to transmit the command signal to the shutdown module.

3. The system of claim 2, wherein the command transmitter couples with a tag module to uniquely identify the command transmitter with respect to other command transmitters near the equipment.

4. The system of claim 3, wherein the command transmitter is adapted to be worn by a person.

5. The system of claim 3, wherein the command transmitter comprises an override switch to transmit the command signal upon depression of a button.

6. The system of claim 3, wherein the command transmitter is adapted to transmit a code sequence, the code sequence being the command signal.

7. The system of claim 6, wherein the command transmitter is adapted to encrypt the code sequence and transmit the encrypted code sequence to the shutdown module.

8. The system of claim 1, further comprising a logic module to interface with another system to instruct the other system to perform an action in response to the voice command.

9. The system of claim 1, wherein the voice receiver comprises a filter to remove noise accompanying the voice command.

10. The system of claim 1, wherein the voice command interpreter is adapted to identify phonemes in the voice command to compare against phonemes stored in memory, which are associated with the instruction.

11. The system of claim 1, wherein the voice command interpreter comprises logic to compare the voice command from an operator against at least a representation of the word “STOP” or other predetermined exclamation, as yelled by the operator, wherein the representation is stored in the memory.

12. The system of claim 1, wherein the voice command interpreter comprises logic to recognize a scream of terror by a human voice as the voice command and associate the voice command with the instruction to shut down the equipment.

13. The system of claim 1, wherein the shutdown module comprises a relay having contacts coupled with a control circuit for the equipment to disconnect power from the equipment in a first state and to facilitate the provision of power to the equipment when the contacts are in a second state.

14. A method to shut down equipment via a voice command, the method comprising:
receiving the voice command;
identifying features of the voice command;
comparing the features against one or more patterns of features stored in memory to associate the voice command with an instruction to shut down the equipment;
generating a command signal in response to associating the voice command with the instruction; and
shutting down the equipment in response to the command signal.

15. The method of claim 14, wherein receiving the voice command comprises receiving sound waves via air, the sound waves having phonemes associated with the instruction to shut down the equipment, the phonemes being the features.

16. The method of claim 14, wherein receiving the voice command comprises receiving vibrations from the person via contact with a person that utters the voice command.

17. The method of claim 14, wherein identifying features of the voice command comprises applying one or more filters to the voice command to accentuate the features of the voice command with respect to noise.

18. The method of claim 14, wherein comparing the features comprises analyzing a time frame of the voice command to identify a phoneme within that time frame, which is associated with the instruction.

19. The method of claim 14, wherein comparing the features comprises comparing the voice command from an operator against at least a representation of the word “STOP” or other predetermined exclamation as yelled by the operator, wherein the representation is stored in the memory.

20. The method of claim 14, wherein comparing the features comprises recognizing a scream of terror by a human voice as the voice command and associating the voice command with the instruction to shut down the equipment.

21. The method of claim 14, wherein shutting down the equipment comprises disconnection power from portions of the equipment.

22. A computer program product comprising a computer-readable medium containing instructions to shut down equipment via a voice command, wherein the instructions, when executed by a machine, cause said machine to perform operations, comprising:
receiving the voice command;
identifying features of the voice command;
comparing the features against one or more patterns of features stored in memory to associate the voice command with an instruction to shut down the equipment;
generating a command signal in response to associating the voice command with the instruction; and
shutting down the equipment in response to the command signal.

23. The computer program product of claim 22, wherein receiving the voice command comprises receiving vibrations from the person via contact with the person, wherein the vibrations are indicative of an utterance of the voice command by the person and have a pattern associated with the instruction to shut down the equipment.

24. The computer program product of claim 22, wherein identifying features comprises identifying phonemes in the voice command to compare with patterns of phonemes in memory, which are associated with the instruction.

25. An apparatus to identify a voice command and responsively transmit an instruction to shutdown equipment, the system comprising:
a voice receiver to receive the voice command;
a voice command interpreter to identify features of the voice command, compare the features against one or more patterns of features stored in memory to associate the voice command with an instruction to shut down the equipment, and output the instruction response to associating the voice command with the instruction; and
an instruction transmitter coupled with the voice command interpreter to transmit the instruction to shut down the equipment in response to output of the instruction by the voice command interpreter.

26. The apparatus of claim 25, further comprising a noise receiver to receive background noise from the environment surrounding the apparatus and a filter to substantially remove the background noise from the voice command as received by the voice receiver.

27. The apparatus of claim 25, wherein the apparatus is a hard hat and the voice receiver couples with a head band of the hard hat.

28. The apparatus of claim 27, further comprising a noise receiver coupled with a shell of the hard hat.
